(19) United States
(12) Patent Application Publication
(10) Pub. No.: US 2005/0255437 A1
(43) Pub. Date: Nov. 17, 2005

(54) Process of relaying a story having a unique plot

(76) Inventor: Andrew F. Knight, Vienna, VA (US)

Correspondence Address: ANDREW F. KNIGHT, 2770 AIRLINE GOLDMINE RD., CANON, GA, 30520, US

(21) Appl. No.: 10/846,544

(22) Filed: May 17, 2004

(51) Int. Cl. G09B 25/00

(52) U.S. Cl. 434/317; 434/365

(57) ABSTRACT

A process of relaying a story having a timeline and a unique plot involving characters includes: indicating a character's fear of acting in a particular manner or performing a particular task, indicating the character being provided with a virtual reality environment, indicating that the character's fear is reduced or eliminated in the virtual reality environment, and indicating a belief of the character that the character is in the virtual reality environment at a time in the timeline in which the character is not in the virtual reality environment.

### BACKGROUND OF THE INVENTION

Virtual reality, particularly that generated by electronic human-computer interfaces, is relatively new, and has not been sufficiently exploited in new, interesting, stimulating plots in movies, books, and other forms of entertainment. Movies such as The Matrix and The Thirteenth Floor are among the few movies that have successfully incorporated virtual reality (and its potentially quirky effects) into their plots.

### SUMMARY OF THE INVENTION

The present invention aims to solve one or more of these and other problems.

According to one embodiment, a process of relaying a story having a timeline and a unique plot involving characters comprises: indicating a character's fear of at least one of acting in a particular manner and performing a particular task; indicating the character being provided with a virtual reality environment having a characteristic; indicating that the character's fear is at least one of reduced and eliminated in the virtual reality environment due to the characteristic; and indicating a belief of the character that the character is in the virtual reality environment at a time in the timeline in which the character is not in the virtual reality environment. The virtual reality environment may be electronically generated. Each of the steps of indicating may comprise indicating in a written or video form.

In one aspect, the process may further comprise indicating that, at the time, the character is the at least one of acting in a particular manner and performing a particular task. In one aspect, the process may further comprise indicating that the at least one of acting in a particular manner and performing a particular task is beneficial to the character. In one aspect, the process may further comprise indicating that the character is not willing to the at least one of act in a particular manner and perform a particular task when the character does not believe that the character is in the virtual reality environment.

In one aspect, the characteristic is that consequences of the at least one of acting in a particular manner and performing a particular task are limited to the virtual reality environment. In one aspect, indicating a belief further comprises indicating that the character has been tricked into believing that that the character is in the virtual reality environment at the time.

In one aspect, the process may further comprise: indicating another character's compassion for the character; and indicating the another character causing, at least one of directly indirectly, the character to be provided with the virtual reality environment and to have the belief.

In one aspect, indicating a character's fear comprises indicating the character's fear of performing a particular task, wherein the particular task comprises a step toward improving a career of the character. In one aspect, indicating a character's fear comprises indicating the character's fear of performing a plurality of particular tasks, wherein the plurality of particular tasks comprises at least two of: a step toward improving a career of the character; a step toward improving a love life of the character; and a step toward improving a relationship with at least one of a close friend and a family member.

In one aspect, the process may further comprise indicating that a virtual reality generating device generates the virtual reality environment by displaying to the character display images based at least in part on images taken of a time period in a life of the character. In one aspect, the process may further comprise indicating the character wearing a camera configured to generate the images and to transfer the images to the virtual reality generating device. In one aspect, in the virtual reality environment, the character may experience in an altered manner stimuli perceived in the time period, wherein the altered manner is due at least in part to an ability of the character in the virtual reality environment to respond to the stimuli in a manner differently than the character responded to the stimuli in the time period. In one aspect, the virtual reality environment is animated, whereby the images taken of the time period may be used to generate fictitious events in the virtual reality environment. In one aspect, the virtual reality environment is interactive, whereby the fictitious events are generated interactively in response to at least one of words and actions of the character.

In one aspect, the process may further comprise: indicating at a first time in the timeline that the character does not believe the virtual reality environment to be realistic because consequences of actions of the character are not believable; indicating that the virtual reality environment has been altered; and indicating at a second time in the timeline that the character believes the virtual reality environment to be more realistic because consequences of actions of the character are more believable.

In one aspect, the process may further comprise: indicating at least one of the character and a second character being provided with a second virtual reality environment; and indicating that a virtual reality generating device generates the second virtual reality environment by displaying display images derived from images taken of a time period in a life of a third character.

In one aspect, the process may further comprise: indicating the character learning that the character was not in the virtual reality environment at the time; and indicating that the character has learned to overcome the character's fear.

In one aspect, the process may be a process of displaying a motion picture having a timeline and a unique plot, comprising: displaying a video representation of an actor acting as the character; displaying a video representation of the actor indicating the fear of at least one of acting in a particular manner and performing a particular task; displaying a video representation of an indication that the character is provided with the virtual reality environment; displaying a video representation of an indication that the character's fear is at least one of reduced and eliminated in the virtual reality environment; and displaying a video representation of the actor indicating the belief.

In one aspect, the process may be a process of creating a motion picture having a timeline and a unique plot, comprising: creating a video representation of an actor acting as the character; creating a video representation of the actor indicating the fear of at least one of acting in a particular manner and performing a particular task; creating a video representation of an indication that the character is provided with the virtual reality environment; creating a video representation of an indication that the character's fear is at least one of reduced and eliminated in the virtual reality environment; and creating a video representation of the actor indicating the belief.

In one aspect, the process may be a process of creating a motion picture having a timeline and a unique plot, comprising: providing a set; providing a video camera configured to video at least a portion of the set; inciting an actor to act as the character; inciting the actor to indicate the fear of at least one of acting in a particular manner and performing a particular task; creating a first video segment via the video camera by filming the indication of the fear by the actor; inciting the actor to indicate the belief; creating a second video segment via a video camera by filming the indication of the belief by the actor; editing and combining at least part of at least the first and second video segments to form a motion picture; and storing the motion picture on an information storage medium.

In one aspect, the process may be a process of creating a motion picture having a timeline and a unique plot, comprising: inciting an actor to act as the character; inciting the actor to indicate the fear of at least one of acting in a particular manner and performing a particular task; and inciting the actor to indicate the belief.

According to another embodiment, an information storage medium contains information of a story having a timeline and a unique plot involving characters, the information comprising: an indication of a character's fear of at least one of acting in a particular manner and performing a particular task; an indication of the character being provided with a virtual reality environment having a characteristic; an indication that the character's fear is at least one of reduced and eliminated in the virtual reality environment due to the characteristic; and an indication of a belief of the character that the character is in the virtual reality environment at a time in the timeline in which the character is not in the virtual reality environment. The information storage medium may be a book.

In one aspect, the medium contains video information of a motion picture, the video information comprising: a video representation of an actor acting as the character; a video representation of the actor indicating the fear of at least one of acting in a particular manner and performing a particular task; a video representation of an indication that the character is provided with the virtual reality environment; a video representation of an indication that the character's fear is at least one of reduced and eliminated in the virtual reality environment; and a video representation of the actor indicating the belief. The information storage medium may be a DVD.

According to another embodiment, a program product for relaying a story having a timeline and a unique plot involving characters comprises machine-readable program code for causing, when executed, a machine to perform the following process steps: indicating a character's fear of at least one of acting in a particular manner and performing a particular task; indicating the character being provided with a virtual reality environment having a characteristic; indicating that the character's fear is at least one of reduced and eliminated in the virtual reality environment due to the characteristic; and indicating a belief of the character that the character is in the virtual reality environment at a time in the timeline in which the character is not in the virtual reality environment.

### DETAILED DESCRIPTION OF PREFERRED EMBODIMENTS

The following described plot may be applied to any form of entertainment, including motion pictures (movies), books, plays, television movies or episodes, radio shows, and may further be applied to any form of media, including video, audio, or written commercial advertisements, video, audio, or written news, etc.

A theme of the present plot is that humans are capable of truly great things, but are often held back from greatness by irrational fears, which may include inhibitions, hesitance, momentum, risk aversion, and other emotions preventing humans from making changes for the better. These fears often prevent people from taking the most beneficial paths—i.e., the paths that would allow them the most success, happiness, etc. Once these fears are assuaged, a person may surprise himself with his ability to achieve success and happiness.

A preferred embodiment of the present plot invention will now be described. The setting is preferably the near future, when computers and software have sufficiently matured that realistic virtual reality generating devices are readily available in the free market, in an urban or suburban section of the United States. Of course, these details, as well as any other detail described herein, may be altered without deviating from the scope of the present invention. The protagonist, whose name might be Nick, is preferably a young or middle-aged man, although could be a woman or of any age. Nick's life is far below what he considers “par,” because, while he sees his own potential, he puts off/procrastinates making any important changes to his life to achieve that potential, for fear of the possibility of failing, even though he continually convinces himself that “the day will come” when he makes a big change and pursues his real dreams without fear. So, in virtually every important choice in his life, he takes the less risky alternative—i.e., the road most traveled. One of ordinary skill in the art will recognize hundred and thousands of possible decisions (ranging from very important to very minor) in which Nick may settle for the less risky and more secure, albeit less beneficial and less successful, alternative. The following plot and examples are examples only, and are not intended to limit the scope of the present invention.

In one embodiment, Nick settles for a secure job in a company in which his pay and responsibilities are relatively low. He is far smarter, more creative, and more capable than his supervisors and other bosses, but he allows them to suppress his ideas and abilities so that he may ensure a ripple-free, predictable, secure career. For example, perhaps Nick is the leader of a small research and development group that has been working on several new products that may be marketed and sold by the company. His supervisor had been a contributor to one of the products (Product A), which is now outdated and far inferior to the other products that the group has since invented and developed (without the supervisor's help). Of course, the supervisor insists on the marketing and sale of Product A, and thus insists that Nick continually assert (e.g., to upper management and stockholders) that Product A is superior, when in fact it is far inferior to the other products, such as a Product B. Nick suspects that, were he to expose and endorse Product B (by explaining how it is superior and far more profit-generating than Product A), he would be promoted and his superior fired or demoted. However, he knows there is a risk that such a bold move will backfire, resulting in Nick being fired or demoted. Thus, day after day, he fails to take a step toward improving his career by telling upper management and stockholders about Product B and other potentially valuable, but as-of-yet unknown products. In other words, he continues to endorse Product A because of fear, and as a result his career remains at the mercy of an incapable, unkind supervisor. Of course, there are many ways in which a person fails to take steps toward improving his/her career because of fear of the risk of failure. All such ways that are currently known in the art (such as those that currently exist in movies, books, plays, etc.) are herein incorporated by reference.

In another embodiment, Nick settles for a girlfriend who walks all over him, berates him, and with whom he has little in common, because he has already “invested” so much time in their relationship, he is afraid to start over with someone else, and he is also afraid that no other woman will be interested in him. In other words, he fails to take a step toward improving his love life because of fear. He prefers the certainty of a bad love life than the uncertainty of obtaining a good one. The ways in which a couple's relationship may be poor, and the fear that prevents members of the couple from ending the relationship and searching anew, are so well known in the art that further description is not necessary.

In another embodiment, Nick settles for a nonexistent or poor relationship with one of his parents (such as his father), because he is scared to confront him and ultimately forgive him for some past deed. For example, perhaps he caught his father cheating on his mother several years or decades ago, and as a result he has not since talked to his father. He fails to take a step toward improving or re-establishing his relationship with his father because he is afraid of again being hurt by his father. He knows that he would probably feel much better if he confronted his father, condemned his actions, forgave him, and then finally tried to re-establish his relationship with him, but he is afraid of the necessary confrontation and possible further anger, and prefers to avoid the matter altogether. Again, the ways in which a past good relationship between family members or close friends may be soured, and the fear that prevents mending of the relationship, are so well known in the art that further description is not necessary.

Other aspects of Nick's life may also be below his expectations, from something very minor such as continuing to drive a car having no air conditioning in the summer, to something major such as being continuously mistreated by coworkers, parents, siblings, government officials, companies, etc. Any way known in the art in which aspects of a person's life may be undesirable but changeable is herein incorporated by reference.

So, in some way or another, Nick has settled for a life that is less than is possible, because of the fear of losing everything in an attempt to improve his life. One or more of the problems mentioned previously may afflict Nick, such as having an undesirable career path, an undesirable love life, an undesirable relationship with his family, and so forth, all of which he wants badly to change, the change of which requires a courage that he does not believe he has.

One day, someone who cares very much for Nick, such as a brother or best friend, and who knows about Nick's fears and troubles, gives him, such as for a birthday present (although it could be for any occasion or reason), a one-week or one-month pass (or a pass that is not limited in time) to what appears to be a virtual reality stress management program. The program will be discussed as follows. In the program, a person may relieve stress by “being” another person in virtual reality (or, alternatively, re-experiencing a time period in one's own life, as will be discussed later). The virtual reality is preferably electronically generated by a virtual reality generating device, preferably comprising a stereoscopic headset having two screens, each screen available for viewing by one eye so as to create a 3-D image viewable by the user, as well as electric stereo headphones, so as to create a stereo sound listenable by the user. The virtual reality generating device may also provide stimuli for other senses, such as tactile, taste, and olfactory senses. The device runs software that provides the user a virtual reality corresponding to an actually measured and/or fictionally programmed (i.e., animated) reality of another person. For example, while in the virtual reality, the user could “be” a celebrity interacting with the virtual world, or could “be” a character in a movie interacting with the world of that movie.

Such software could be implemented in at least one of the following manners. First, a celebrity (or any other person) could wear a stereo video camera, stereo microphone, and any other sensor necessary to create a virtual reality, as well as either a recording and storage device (e.g., processor and hard drive (e.g., magnetic or optical)) or a transmitting device configured to transmit information acquired from the camera/microphone sensors to a receiver connected to a recording and storage device. Of course, in the near future, such cameras, microphones, storage devices, and transmitters will likely be exceptionally small, so that carrying these devices around will not burden the celebrity. For example, the video camera may comprise a small device that may be placed on a contact lens or other lens mountable on the surface of one's eyeball, so that it may be placed comfortably directly on the celebrity's eyeball (preferably one camera for each eye), allowing the cameras to image exactly what the celebrity sees, in substantially exactly the same way. Further, the microphones may be sufficiently small that they may be mounted on or in the celebrity's ears, such as on earrings or actually inside the ears, so that the microphones sense exactly what the celebrity hears, in substantially exactly the same way. The same may be true for other sensors (e.g., placing a flavor sensor on the celebrity's tongue, etc.). The information from these sensors may be collected over a time period, and ultimately saved to a storage device.

Next, the user of the virtual reality generating device may experience the experiences of the celebrity during the time period, by wearing stereoscopic goggles that project the 3-D images imaged by the video cameras into the user's eyes, and by wearing stereo headphones that produce sound corresponding to the sounds sensed by the microphones, etc. (Again, the information need not have been collected by a “celebrity”; it may have been collected by any person, but the word “celebrity” will continue to be used to indicate the person whose stimuli are being recorded.) Thus, a person may be able to experience the stimuli experienced by a President Elect being sworn in, or by a famous scientist and winning the Nobel Prize, or by a talented actress and winning a prestigious award, etc.

Further, the images and sounds sensed by the sensors on the celebrity may be altered by a processor implementing animating software, such that practically any series of events may believably be created by the virtual reality generating device. In other words, the sensed images and sounds may be used as a backdrop or background, and may also or alternatively be used as a template for animation by the virtual reality. For example, assume that the celebrity, at some point during the recorded time period, had a conversation with a particular person. The face image and the voice features of the person may be overlaid or superimposed on top of a generic animated figure in the virtual reality, and the animated figure controlled or animated according to any instruction implemented by the software, user, or programmer. For example, perhaps the celebrity had a conversation with President Jacques Chirac of France, who during the course of the conversation stated, “We do not support those dirty, American capitalists.” The animation software may then, in response to an instruction by a programmer, digitally extract the image of Chirac's face and body and superimpose it onto a controllable animated figure, and extract the sound of Chirac's voice and superimpose it onto a controllable sound animation. The processor and software finally create an animation of Chirac pointing to his waist and exclaiming, “I am wearing pink underwear.”

Thus, using intelligent animating software, a personalized virtual reality may be generated for a user, based at least in part on the information sensed by the sensors carried by the celebrity. In other words, a user may experience the recorded time period of the celebrity's life, or may experience an animated and fictitious (and perhaps more entertaining) version of the celebrity's life. Further, the virtual reality may be interactive, so that the events experienced by the user in the virtual reality depend on choices made, words stated, or actions performed by the user. For example, the user may have an interactive conversation with a virtual person, where the words and movements of the virtual person are generated and animated on the fly, in response to the words and actions of the user. Of course, the animation may be programmed from scratch by intelligent programmers, and may not be based at all on a time period of a person's life recorded by cameras, sensors, etc. Preferably, however, the virtual reality experienced by the user, animated or not, has the appearance of reality, preferably not the appearance of cartoon animations.

Of course, not only may a user experience a time period of another's life, he may, if he is willing to record a time period of his own life using attached video cameras and microphones, etc., re-experience a time period of his own life. More importantly, because these images and sounds may be used to create a fictitious animated set of events which may or may not be interactive with the user, the user may use the virtual reality to “redo” something that he failed at the first time, or to act in a past experience in a way that he normally would not act. For example, a man is trying to impress a woman so that she will go out with him, but he ends up saying something offensive or embarrassing, or he otherwise fails. Had he been recording the event, he could then transfer the information to the virtual reality generating device, and be able to retry the effort. Of course, the virtual woman, who is in fact animated, may be programmed to be particularly receptive to the man's advances, or may be programmed to a realistic and believable level of receptiveness, etc. Thus, the man may use the virtual reality to release stress or increase confidence by programming the virtual woman to be impressed by him, no matter what he says. Alternatively or in addition, he may use the virtual reality to practice his social methods by programming the virtual woman to respond in more realistic ways. In other words, the virtual reality is controllable so that its interactive aspects (e.g., the relationship between cause and effect) may be adjusted to be more or less believable and realistic.

As another example—and of course there are millions of possible scenarios in which a user would want to “redo” or re-experience a past event in an interactive virtual reality environment—a person has been mistreated by her boss. In real life, she may have absorbed his nasty words and condemnation without retaliation, to prevent from being fired or to prevent further unpleasant confrontations. However, if she had recorded the time period, she may transfer this information to the virtual reality generating device and interact with her virtual boss in the virtual reality environment in a manner that is more cathartic and stress-relieving than in real life. She may, for example, tell her boss off, or she may punch him, or she may act particularly silly (i.e., a manner in which she would normally not act), such as crossing her eyes and walking away. The virtual reality may be programmed such that the virtual boss acts in a way that he realistically would act in such a scenario, or it may be programmed so that the virtual boss acts unrealistically, such as particularly submissive, apologetic, or otherwise pathetic. Thus, in the virtual reality environment, a user's fear of acting in a particular manner or doing a particular thing or task may be eliminated or assuaged.

Having described the virtual reality generating device, the plot according to a preferred embodiment will now be further described. At first, the unhappy protagonist Nick may be happy to enter the virtual reality environment in some of many available predetermined scenarios (such as driving in a race car or winning a professional boxing match) or as some of many available predetermined celebrity personalities, as discussed previously, to relieve stress by experiencing unique experiences and/or those of another person. The virtual reality stress management program may be owned and operated by a very kind, intelligent, cynical, funny (but at times very serious) man who both operates the program and counsels the participants in relieving their stress. His name may be Mr. Hodges, he may be an older gentleman, and he may appear at some point in each of the virtual reality experiences or “apparitions” to talk through the virtual reality session with the participant and to help the participant make the most of the experience. Thus, he may serve as an advisor and, particularly to Nick, a friend. (Of course, this character is not necessary to the plot, and may be eliminated, or may be a lesser character, and/or may act or do things differently than suggested.) After Nick has had several interesting virtual reality experiences, Mr. Hodges suggests that he try a more personal (and thus more emotionally releasing experience): reliving a time period of his own life. Of course, Nick refuses, fearing what doing so might drive him to do. Mr. Hodges nevertheless insists that Nick take a body-mountable camera and microphone set with him.

In a later scene, Nick has a very unpleasant experience due to his fears. For example, he works with a woman who is very intelligent, beautiful, and kind, and he has long wanted to end the destructive relationship with his girlfriend and take his co-worker out to dinner. In the present scene, he may have had a very nice conversation with the woman, in which a wonderful opportunity arose to ask her out or get to know her better. Of course, the fear of losing his present relationship paralyzed him, and he did nothing. Alternatively or in addition, any other unpleasant experience that is due to his fear may occur. As a result, he seriously considers Mr. Hodges' words, and he finally decided to wear the camera and microphone set so as to record images and sounds corresponding to his experiences while wearing them. As discussed later, other methods of obtaining this information (images and sound, etc.) are within the scope of the present invention, and Nick may use one of these methods instead. Further, perhaps Nick never had any inhibitions to wearing the sensors, and did so as soon as suggested by Mr. Hodges.

Next, Nick has another unpleasant experience due to his fears, and he transfers the information recorded by the sensors to the virtual reality generating device and, with Mr. Hodges' help, he relieves his stress and frustrations by reliving, over and over in different ways, the stimuli that he recorded. At first, Nick may (or may not) ask that the virtual reality animation software be programmed to allow Nick a virtual “omnipotence.” For example, in a virtual encounter with his girlfriend, Nick freely and without inhibitions tells her that she has been holding him back from having a good relationship, and he instructs her to punish herself. She submissively obliges by spanking herself while apologizing profusely. As another example, in a virtual encounter with his supervisor, Nick tells his supervisor what he thinks of him, and insists that his supervisor fire himself. His supervisor happily obliges, while at the same time offering Nick the keys to his new Mercedes. Nick may have various other unrealistic, yet very entertaining, fun, and emotionally releasing virtual reality experiences. In each subsequent visit to Mr. Hodges' virtual reality device, Nick insists on less and less realism/believability, as in each virtual reality experience Nick becomes more godly (i.e., he becomes more and more powerful), until in a final experience nothing is realistic and Nick can make anything happen with no effort.

“Bored yet?” asks Mr. Hodges. Nick finally realizes that a virtual reality environment in which cause and effect are fully divorced—i.e., in which Nick can make any woman like him no matter what he says or does, he can become the President of any company no matter how poorly he conducts business, he can take the world over with no effort—is valueless, because it teaches him nothing, and its thrill quickly passes. He may then ask Mr. Hodges to program the virtual reality software to make its interactive animations realistic and believable. Thus, for example, in future virtual reality experiences, Nick's supervisor fires him when Nick shows up late or fails to work, his girlfriend screams at him when he tries to break up with her, etc. However, even though these experiences are more realistic (i.e., events are more causally connected), Nick remains completely uninhibited in these experiences because he knows that the consequences of his actions and words are limited and do not extend beyond the virtual reality experience. Thus, he is free to try various ways of dealing with each recorded event without fear of failure or fear of making things worse. In each future virtual reality experience, Nick gets better and better at dealing with his stressors and solving his problems, because he continually learns from his mistakes. He soon realizes that, in most circumstances, he already knew (and had always known) the proper solutions to his problems, but that fear prevented their execution.

At the end of the program, Mr. Hodges tells Nick that he and his programmers have prepared a very special, day-long interactive virtual reality animation experience, which incorporates most of the stressors and ongoing problems of Nick's life, and that this ultimate stressor confrontation program will be what Nick needs to finally end his fears of change and of success. This special day-long program has been timed to occur the day before an important shareholder's meeting of Nick's company, where Nick was to again endorse his supervisor's Product A. Because it is a day-long program, Mr. Hodges suggests that he sleeps at the program's office, and tells Nick that the next morning he will wake up in the virtual reality, his final opportunity to practice what he had learned before trying it in the real world.

Nick wakes up in his own bed on what he perceives to be the next morning, ready to face the day. As usual, Mr. Hodges is before him in “apparition” form, greeting Nick and advising and counseling him about the day, and lets Nick know that he is in for a special surprise, first at the beginning of the shareholder's meeting, and finally at the end of the meeting. Nick goes to work and prepares for the meeting. A little bit before it began, he sees his father in the meeting room, apparently confused, and he approaches his father, who tells Nick that he had received an odd phone call, instructing him to appear at the shareholder's meeting. Without fear or hesitance, Nick tells his father how he feels, that he felt betrayed, and that he believes his father's actions were cruel and disloyal. Nick also tells him that he misses him and wants to forgive him, and that despite the past he wants him to be a part of his life. The conversation is emotional but direct, and at the end the men embrace and promise to get re-acquainted.

In the middle of the shareholder's meeting, during Nick's presentation regarding the company's product line, he fearlessly deviates from his supervisor-approved presentation and begins talking about Product B. His supervisor turns off Nick's microphone, but this doesn't stop Nick, who continues speaking loudly to the large meeting room full of shareholders. He discloses years' worth of deception imposed by his supervisor, and successfully convinces the shareholders that Product B must be the company's next profitable step. Of course, his presentation is a resounding success, the meeting room rumbling with applause and whistles, his supervisor resigning on the spot, and several directors congratulating Nick and suggesting a big promotion. Nick's attractive co-worker is also at the meeting, and directly afterward, while Nick is still shining in the shareholders' applause, he directly approaches her and says several very nice things, and without inhibition asks her to dinner. She smiles and agrees. Also in the audience was Nick's girlfriend who sees this conversation. Nick accidentally runs into her, and tells her that things are over, and to pack her things and leave immediately. His directness and fearlessness intimidate her, and she says nothing more as she walks away.

While walking out of the meeting, arm-in-arm with his co-worker and with “congratulations” ringing in the background, Nick sees Mr. Hodges. “If only things could turn out this perfect in real life,” Nick says. “They did,” Mr. Hodges replies, and points to Nick's brother, who says, “Happy birthday, Nick.” Nick's eyes widen as he slowly realizes that the entire day he had been tricked into believing he was having a virtual reality experience, when in fact the experience had been real. Needless to say, Nick begins a new life, always acting confidently and fearlessly to make the best choices and to live his life to the fullest.

Of course, the above climax and resolution are specific to whatever beneficial actions and decisions the protagonist had been avoiding due to fear. If the protagonist had always wanted to climb a mountain or sail a boat (or whatever) and had never done so for fear, then of course the conclusion of the plot should deal with satisfaction of these desires and dreams. The above described plot is merely one possible embodiment of many.

There are many possible ways in which Nick may be fooled into believing it is the day before the shareholders' meeting. For example, Mr. Hodges could change all of his clocks and calendars, or he may drug Nick to sleep through the day before the stockholders' meeting, and so forth. Further, the special one-day “virtual reality” program need not be based around a particular day at all. Perhaps Nick is capable of making important, life-changing and life-improving decisions everyday, but fails to do so everyday. Thus, Mr. Hodges may arbitrarily choose a day to “set Nick free,” such as when he believes that Nick has learned how to tackle his fears and how to make beneficial decisions.

Many variations on this plot are possible. For example, in the above described embodiment, Nick's virtual reality environment was created by an electronic virtual reality generating device. However, other ways of creating virtual reality environments are within the scope of the present invention. For example, technology may be available far in the future to create virtual realities in one's head by altering one's brain (e.g., using electromagnetic waves or other known “sci-fi forces”), without the necessity for 3-D head-mounted displays and headphones, etc. Conversely, similarly exotic technology may be used to extract the relevant images/stimuli from Nick's head (for subsequent use by the virtual reality generating device) without the need for cameras, microphones, and/or other sensors. As another example, a virtual reality may be created by, e.g., physically constructing an appropriate setting and utilizing human actors/actresses to act in ways that simulate a reality for the user. See, e.g., The Truman Show, the plot of which is herein incorporated by reference. For example, an actress could, using prosthetic masks, costumes, and make-up, make herself appear as Nick's girlfriend, and could act as his girlfriend, etc., so as to simulate Nick's reality. Such a scheme is relatively elaborate, but could be appropriate for a movie plot regarding a relatively wealthy character. See, e.g., The Game, the plot of which is herein incorporated by reference. Similarly, information regarding Nick's life may be gleaned by inquiry (such as by a trained psychologist) instead of cameras, microphones, etc.

Dynamic characters make interesting plots. Clearly, Nick is dynamic, but perhaps in too predictably a manner. Perhaps Mr. Hodges is also dynamic, in that perhaps, until Nick's arrival to the program, Mr. Hodges only provided fun, stress-relieving virtual reality experiences. Then, upon meeting and working with Nick, Mr. Hodges slowly comes to believe in the strength and power of the human soul, and begins to believe that Nick could actually achieve all of his dreams if he had confidence. Thus, Mr. Hodges evolves as a teacher and an advisor, and learns an important lesson about life.

Further, Nick's brother (or the compassionate character) causes Nick to be provided with the virtual reality environment by enabling Nick to do Mr. Hodges' virtual reality program, and ultimately causes Nick (albeit indirectly via Mr. Hodges' program) to be fooled in the one-day “virtual reality” program.

Further, Nick may have clearly indicated to Mr. Hodges that he never intended to utilize what he learned from the virtual reality experiences, perhaps because he doesn't believe that the good effects that result in virtual reality from his reduced inhibitions/fears will happen in real life, and perhaps he just doesn't want to take the risk of failing. Nick might have explicitly stated it, or Mr. Hodges may suspect it by having observed Nick in real life failing to make the same valuable decisions that he ordinarily makes in virtual reality. In this embodiment, the fact that Nick is tricked into fulfilling his dreams in reality is all the sweeter, because it may never have happened otherwise.

Further, Nick may finally discover that his one-day “virtual reality” program was not virtual reality at all in any number of ways, such as being explicitly told or observing something that is inconsistent with his being in virtual reality. For example, perhaps in virtual reality he cannot smell anything, because this particular virtual reality generating device has no smell-generating features, and when he finally approaches his attractive co-worker at the end, he notices her perfume. Or perhaps Mr. Hodges, when he appears in each experience or apparition, “beams” himself in and out, but in the final one-day program, Nick notices that he walks up to him (instead of beaming himself in front of Nick). Other ways in which Nick notices that the world he observes is inconsistent with the virtual reality experience are within the scope of the present invention.

In a preferred embodiment, several features are indicated, such as the protagonist's fear of acting in a particular way or performing a particular task, and the protagonist's belief (near the end of the plot) that he is in the virtual reality environment when in fact he is not. As well known by those of ordinary skill in the art, there are many ways to indicate a fact in a movie without any explicit words to that effect at all: circumstance, cinematography, subtly suggestive newspaper headlines, suggestive words by the protagonist or other characters, etc., can all be indicative of that fact.

The story preferably has a timeline, which will be well understood by one of ordinary skill in the art. For example, in a story containing flashbacks, the timeline may represent the chronological order in which events occur in the story. Therefore, a flashback may occur earlier in the story's timeline, even though the flashback is presented in a later part of the story.

The present invention applies to any practical application or use of the present plot. For example, the invention includes the processes of relaying a story having the present plot, writing a book having the present plot, printing a book having the present plot, creating a movie having the present plot, displaying or showing a movie having the present plot, filming a movie having the present plot, inciting actors to act out the present plot, creating an audio recording of a story having the present plot, etc. The present invention also applies to any product of any of these processes—e.g., a book containing written information of a story having the present plot, an audio tape or CD disk containing audio information of a story having the present plot, a VHS tape or DVD or VCD disk containing video information of a movie having the present plot, etc.

For example, creating a movie having the present plot may include inciting an actor to act as the protagonist. As will be understood by one of ordinary skill in the art, a producer or director or production company may incite an actor to act as the protagonist by promising a financial or a career-related reward or advancement. Creating such a movie may also include providing a set, as known by those of ordinary skill in the art, video cameras (preferably high-resolution digital video cameras), and editing equipment, and using the set, cameras, and equipment to create video segments of footage of the actors acting consistent with the present plot. The final video may be stored on an information storage medium, duplicated onto VHS tapes or DVDs, and distributed and sold.

Finally, regarding a program product that comprises machine-readable program code for causing, when executed, a machine to perform process steps, the machine could be a VCR or DVD player or similar, and the code could comprise the instructions and/or data which, when read by the VCR or DVD player, causes the VCR or DVD player to perform the indicated process steps, whether directly or indirectly via a monitor (e.g., television screen) and speakers.

1. A process of relaying a story having a timeline and a unique plot involving characters, comprising:
indicating a character's fear of at least one of acting in a particular manner and performing a particular task;
indicating said character being provided with a virtual reality environment having a characteristic;
indicating that said character's fear is at least one of reduced and eliminated in said virtual reality environment due to said characteristic; and
indicating a belief of said character that said character is in said virtual reality environment at a time in said timeline in which said character is not in said virtual reality environment.

2. The process as claimed in claim 1, further comprising indicating that said character is not willing to said at least one of act in a particular manner and perform a particular task when said character does not believe that said character is in said virtual reality environment.

3. The process as claimed in claim 1, wherein said virtual reality environment is electronically generated.

4. The process as claimed in claim 1, wherein said indicating a belief further comprises indicating that said character has been tricked into believing that that said character is in said virtual reality environment at said time.

5. The process as claimed in claim 1, further comprising:
indicating another character's compassion for said character; and
indicating said another character causing, at least one of directly indirectly, said character to be provided with said virtual reality environment and to have said belief.

6. The process as claimed in claim 1, wherein said indicating a character's fear comprises indicating said character's fear of performing a plurality of particular tasks, wherein said plurality of particular tasks comprises at least two of: a step toward improving a career of said character; a step toward improving a love life of said character; and a step toward improving a relationship with at least one of a close friend and a family member.

7. The process as claimed in claim 1, further comprising indicating that a virtual reality generating device generates said virtual reality environment by displaying to said character display images based at least in part on images taken of a time period in a life of said character.

8. The process as claimed in claim 7, further comprising indicating said character wearing a camera configured to generate said images and to transfer said images to said virtual reality generating device.

9. The process as claimed in claim 7, wherein said virtual reality environment is animated, whereby said images taken of said time period may be used to generate fictitious events in said virtual reality environment, and
wherein said virtual reality environment is interactive, whereby said fictitious events are generated interactively in response to at least one of words and actions of said character.

10. The process as claimed in claim 1, further comprising:
indicating at a first time in said timeline that said character does not believe said virtual reality environment to be realistic because consequences of actions of said character are not believable;
indicating that said virtual reality environment has been altered; and
indicating at a second time in said timeline that said character believes said virtual reality environment to be more realistic because consequences of actions of said character are more believable.

11. The process as claimed in claim 1, further comprising:
indicating at least one of said character and a second character being provided with a second virtual reality environment; and
indicating that a virtual reality generating device generates said second virtual reality environment by displaying display images derived from images taken of a time period in a life of a third character.

12. The process as claimed in claim 1, further comprising:
indicating that, at said time, said character is said at least one of acting in a particular manner and performing a particular task; and
indicating that said at least one of acting in a particular manner and performing a particular task is beneficial to said character,
wherein said virtual reality environment is electronically generated, and
wherein said indicating a character's fear comprises indicating said character's fear of performing a plurality of particular tasks, wherein said plurality of particular tasks comprises at least two of: a step toward improving a career of said character; a step toward improving a love life of said character; and a step toward improving a relationship with at least one of a close friend and a family member.

13. The process as claimed in claim 12, further comprising:
indicating another character's compassion for said character;
indicating said another character causing, at least one of directly indirectly, said character to be provided with said virtual reality environment and to have said belief; and
further comprising indicating that a virtual reality generating device generates said virtual reality environment by displaying to said character display images based at least in part on images taken of a time period in a life of said character,
wherein said indicating a belief further comprises indicating that said character has been tricked into believing that that said character is in said virtual reality environment at said time.

14. The process as claimed in claim 13, further comprising:
indicating at a first time in said timeline that said character does not believe said virtual reality environment to be realistic because consequences of actions of said character are not believable;
indicating that said virtual reality environment has been altered;
indicating at a second time in said timeline that said character believes said virtual reality environment to be more realistic because consequences of actions of said character are more believable;
indicating said character learning that said character was not in said virtual reality environment at said time; and
indicating that said character has learned to overcome said character's fear
wherein said virtual reality environment is animated, whereby said images taken of said time period may be used to generate fictitious events in said virtual reality environment, and
wherein said virtual reality environment is interactive, whereby said fictitious events are generated interactively in response to at least one of words and actions of said character.

15. The process as claimed in claim 1, wherein each of said steps of indicating comprises indicating in a written form.

16. The process as claimed in claim 1, wherein each of said steps of indicating comprises indicating in a video form.

17. The process as claimed in claim 1, wherein said process is a process of displaying a motion picture having a timeline and a unique plot, comprising:
displaying a video representation of an actor acting as said character;
displaying a video representation of said actor indicating said fear of at least one of acting in a particular manner and performing a particular task;
displaying a video representation of an indication that said character is provided with said virtual reality environment;
displaying a video representation of an indication that said character's fear is at least one of reduced and eliminated in said virtual reality environment; and
displaying a video representation of said actor indicating said belief.

18. The process as claimed in claim 1, wherein said process is a process of creating a motion picture having a timeline and a unique plot, comprising:
providing a set;
providing a video camera configured to video at least a portion of said set;
inciting an actor to act as said character;
inciting said actor to indicate said fear of at least one of acting in a particular manner and performing a particular task;
creating a first video segment via said video camera by filming said indication of said fear by said actor;
inciting said actor to indicate said belief;
creating a second video segment via a video camera by filming said indication of said belief by said actor;
editing and combining at least part of at least said first and second video segments to form a motion picture; and
storing said motion picture on an information storage medium.

19. An information storage medium containing information of a story having a timeline and a unique plot involving characters, said information comprising:
an indication of a character's fear of at least one of acting in a particular manner and performing a particular task;
an indication of said character being provided with a virtual reality environment having a characteristic;
an indication that said character's fear is at least one of reduced and eliminated in said virtual reality environment due to said characteristic; and
an indication of a belief of said character that said character is in said virtual reality environment at a time in said timeline in which said character is not in said virtual reality environment.

20. A program product for relaying a story having a timeline and a unique plot involving characters, said product comprising machine-readable program code for causing, when executed, a machine to perform the following process steps:
indicating a character's fear of at least one of acting in a particular manner and performing a particular task;
indicating said character being provided with a virtual reality environment having a characteristic;
indicating that said character's fear is at least one of reduced and eliminated in said virtual reality environment due to said characteristic; and
indicating a belief of said character that said character is in said virtual reality environment at a time in said timeline in which said character is not in said virtual reality environment.
